(19) United States
(12) Patent Application Publication
(10) Pub. No.: US 2016/0344231 A1
(43) Pub. Date: Nov. 24, 2016

(54) Charge Controller with Wired or Wireless Communications Network

(71) Applicant: Randolph Earl Bridwell, Sarasota, FL (US)

(72) Inventor: Randolph Earl Bridwell, Sarasota, FL (US)

(21) Appl. No.: 14/715,369

(22) Filed: May 18, 2015

(51) Int. Cl. H02J 7/35; H02J 7/00

(52) U.S. Cl. CPC H02J 7/35; H02J 7/0013; H02J 7/007

(57) ABSTRACT

A modulation control scheme for a Maximum Power Control Tracking (M.P.P.T.) charge controller in a photovoltaic system including one or more Li Iron Phosphate battery and a photovoltaic panel uses an electronic circuit mounted between the battery and the photovoltaic panel. The charge controller has an input connector to the photovoltaic panel, an electronic battery protector chip for protecting the battery from overcharging and undercharging, a wireless communication chip operationally connected to the electronic battery protector, and an output connector connecting the electronic circuit to the battery.

### CROSS REFERENCE TO RELATED APPLICATIONS

This application is a non provisional application application of my co-pending provisional application Ser. No. 62/005,543, filed on May 30, 2014, entitled Charge Controller with Wired or Wireless Communications Network the full disclosure of which is incorporated by reference herein and priority of which is hereby claimed.

### BACKGROUND OF THE INVENTION

1. Technical Field

The present invention relates to devices and methods for using a circuit card or board and chip or chips to control the Maximum Power Point Tracking (M.P.P.T.) charge input and output from a photovoltaic panel or panels to a cell or cells of Lithium Iron Phosphate (LiFePO4) batteries.

2. Background Art

There are various charge controllers that exist for lead batteries, polymer batteries, as well as others, that allow for Maximum Power Point Tracking (M.P.P.T.). M.P.P.T. allows chargers to obtain the maximum amount of power possible from photovoltaic devices. Essentially, the M.P.P.T. reads voltage and if slightly high, turns the voltage into ampage and charges a battery. However, there currently is not a charge controller on the market for charging Lithium Iron Phosphate (LiFePO4) batteries from the input of photovoltaic panels that offers M.P.P.T. and a wired or wireless communications network. There is also not a charge controller existing that has the ability to access power from a photovoltaic panel and a battery bank at the same time.

Therefore, there remains a need for a charge controller using M.P.P.T. with Lithium Iron Phosphate (LiFePO4) batteries and board that can allow power companies to access power from the photovoltaic panels and the battery bank when they need it not just when the sun is shining.

### SUMMARY OF THE INVENTION

The present invention provides for a Lithium Iron Phosphate (LiFePo4) battery charge controller that receives power input from at least one photovoltaic panel, including a circuit board having at least one chip that protects at least one battery from overcharging and undercharging.

The present invention provides a method of using the battery charge controller, by obtaining power from a photovoltaic panel, performing Maximum Power Point Tracking (M.P.P.T.), and charging at least one LiFePO4 battery.

### DESCRIPTION OF THE DRAWINGS

Other advantages of the present invention are readily appreciated as the same becomes better understood by reference to the following detailed description when considered in connection with the accompanying drawings wherein:

FIG. 1 is a top view of the battery charge controller;

FIG. 2 is a side view of the battery charge controller;

FIG. 3 is a back view of the battery charge controller; and

FIG. 4 is a photograph of the battery charge controller.

### DETAILED DESCRIPTION OF THE INVENTION

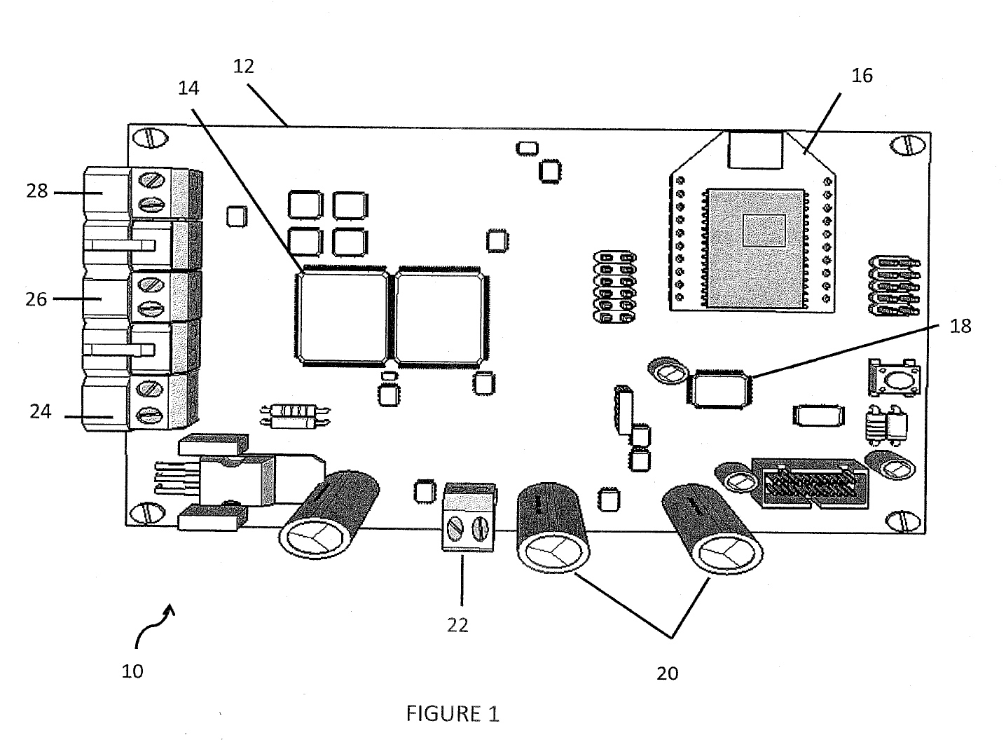

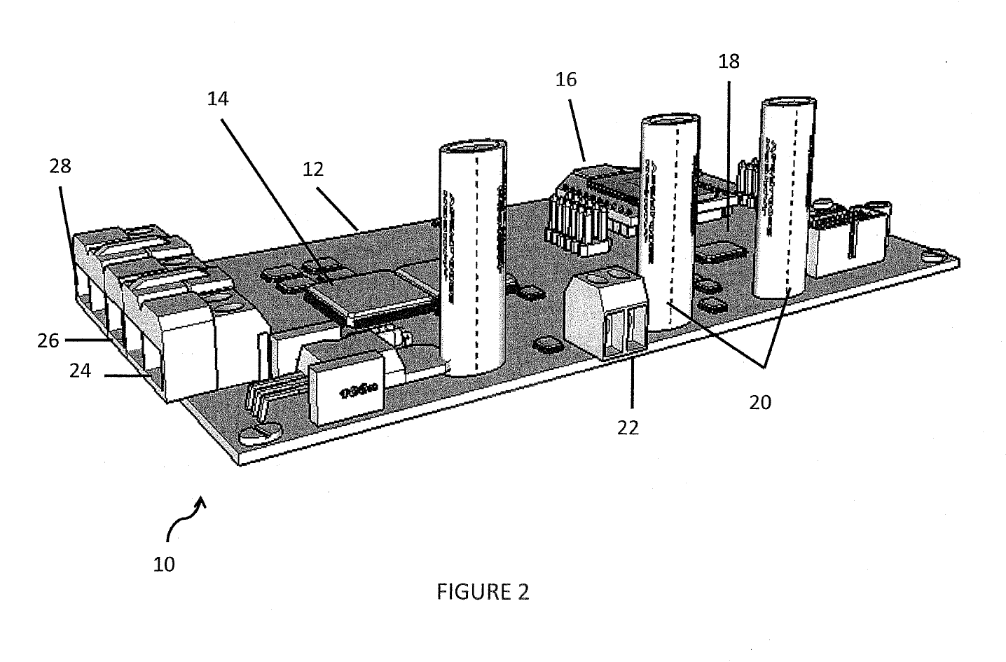

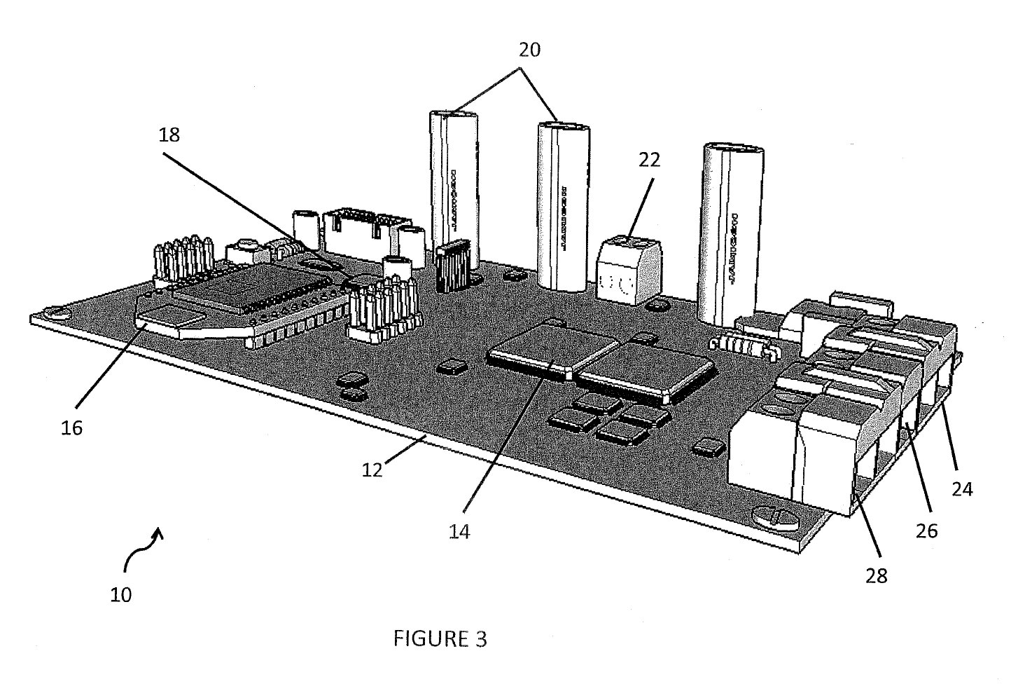

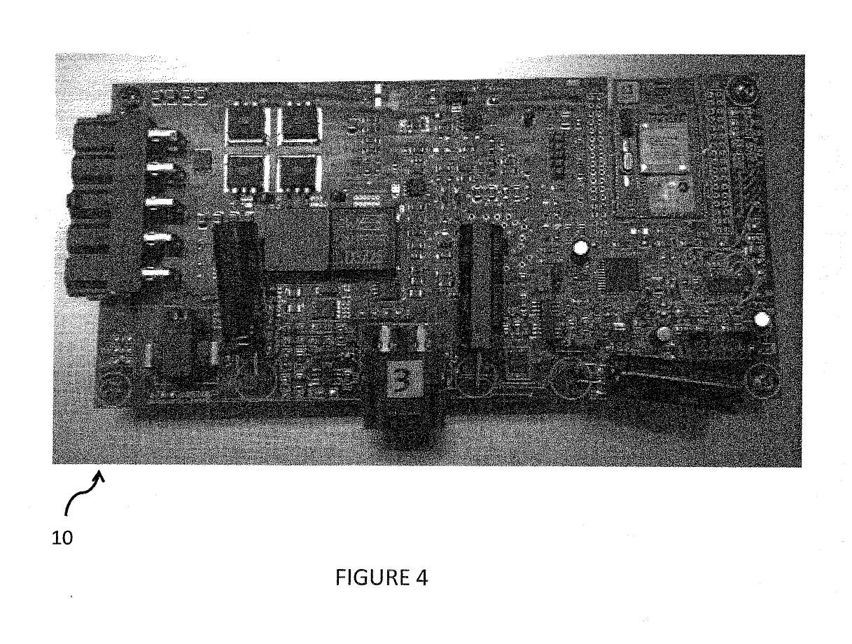

The present invention provides for a Lithium Iron Phosphate (LiFePo4) battery charge controller 10, shown at 10 in FIGS. 1-4, that receives power input from at least one photovoltaic panel (i.e. solar cell), including a circuit board 12 having at least one chip that protects at least one battery from overcharging and undercharging. All of parts herein are in electronic connection with the circuit board and optionally with each other, whether by wired or wireless electronic connection.

The battery charge controller 10 performs Maximum Power Point Tracking (M.P.P.T.). This is performed by at least one chip 14, or by an analog process, or a combination of both a chip 14 and analog. M.P.P.T. analyzes the photovoltaic panel to allow the battery charge controller 10 to operate at an optimal level while the time required to fully charge the battery is reduced.

The battery charge controller 10 uses wired or wireless network communications and includes a wireless network chip 16, and has the ability to allow output from the battery bank and the photovoltaic panel at the same time.

The battery charge controller 10 in this invention is designed to accept input power from at least one photovoltaic panel at an input power connection 22 and provide a single output optimized for charging Lithium Iron Phosphate (LiFePO4) batteries at an output power connection 24. The battery charge controller 10 includes a buck/boost DC/DC converter or chip 18 implemented on a circuit card assembly that can be installed in a housing. Capacitors 20 can be included to stabilize the battery charge controller 10 and work with the M.P.P.T. allowing for the buck/boost function. Ground 26 can be included to ground the battery charge controller 10. A power-in connection 28 can be included for power input from the battery.

The buck/boost battery charge controller 10 is configured to charge Li Iron Phosphate (LiFePO4) batteries. This charger incorporates an onboard wireless communication interface, implemented with a network communication module and includes an onboard microcontroller that controls the overall operation of the battery charge controller 10 and the communications controller. This allows the power supply to be used as needed.

The battery charge controller 10 accepts a wide input voltage range supplied from a photovoltaic panel and provides a regulated CC/CV output optimized for Maximum Power Point Tracking (M.P.P.T.) operation to properly charge at least one cell in series or a parallel (LiFePO4) battery or batteries.

The battery charge controller 10 provides current limited operation, supports automatic shutoff for low battery voltage, and preconditioning of heavily discharged batteries. The battery charge controller 10 can provide the maximum amount of charging current output to maintain the cells. The networks wireless communication interface is accessible and provides the ability to remotely monitor and control the charger operating parameters.

Under normal operating conditions, the battery charge controller 10 is capable of supplying a maximum predetermined amount of output power to the load. When the connected battery is fully charged, the combined outputs of both the battery charge controller 10 and battery can provide up to a maximum of twice the predetermined amount of the total output power to the load.

The battery voltage is continuously monitored to allow the battery charge controller 10 to implement a low battery voltage cutoff function. When the battery charge controller 10 is not operating in charge mode and the battery is sourcing power to the output, if the sensed battery voltage falls below predetermined voltage lower limit, the battery can be disconnected from the load by an onboard solid state disconnect. In other words, a discrete control shutdown can be provided that enables or disables the battery charge controller 10 output. In a disconnect mode, the battery charge controller 10 is disconnected from the output circuit mode. A charge mode can control fault. Alarms (sound, light, text messages, wireless alerts) can also be used to notify individuals of any change in battery charge controller 10 condition.

On board connectors can be provided to allow replacement of input/output cables to support industry standard solar harness connections. Fuse/circuit breaker protection for both PV input and Charger output connections are not located on the charge controller board to allow compliance with NEC Sec 690 code for disconnect of Class 3 equipment (Battery or Solar powered).

A variety of parameters can be measured with the device, such as, but not limited to, input voltage, input voltage from photovoltaic panel output voltage, output voltage delivered to load battery voltage, battery voltage output current, output current delivered to load charge current, charge current delivered to battery, ambient temperature of control board, and combinations thereof.

Particular specifications of the battery charge controller 10 can be as follows:

Input Voltage: 1 VDC to 5000 VDC Maximum

Input Current: 1 Milliamp to 500 Amps Maximum

Input Power: 1 W to 1 MW

Output Voltage: 1 VDC to 5000 VDC

Continuous Output Current: 1 Milliamp to 500 Amps

Maximum Output Current: up to 500 Amps

Low Voltage Battery Disconnect: down to 1V

The present invention provides a method of using the battery charge controller, by obtaining power from a photovoltaic panel, performing Maximum Power Point Tracking (M.P.P.T.), and charging at least one LiFePO4 battery. The method can include providing output from a battery bank and the photovoltaic panel at the same time. The method can further include operating the battery charge controller remotely by a wireless connection. The method can also include, when the battery is fully charged, providing up to a maximum of twice the predetermined amount of the total output power to the load with the combined outputs of the battery charge controller and battery.

The present invention provides several advantages. The battery charge controller 10 charges batteries at the highest optimal level while the time required to fully charge the batteries is reduced. The battery charge controller 10 also prevents reverse-current flow at night, when photovoltaic panels are not generating electricity. The battery charge controller 10 also allows power to be used from the battery bank and the photovoltaic panel at the same time allowing up to twice as much power to be used, than what the photovoltaic panel would normally produce by itself. The battery charge controller 10 also incorporates an onboard wired or wireless communication interface, implemented with a network communication module, and includes an onboard microcontroller that controls the overall operation of the battery charger and the communications controller, and this allow the power supply to be used as needed, as well as operated remotely from anywhere in the world.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

1. A modulation control scheme for a Maximum Power Control Tracking (M.P.P.T.) charge controller in a photovoltaic system including at least one battery and a photovoltaic panel, the modulation control scheme comprising an electronic circuit provided with an input connector to the photovoltaic panel, an electronic battery protection means for protecting the at least one battery from overcharging and undercharging, a network communication device operationally connected to the electronic battery protection means, and an output connector connecting the electronic circuit to the at least one battery.

2. The modulation control scheme of claim 1, wherein the network communication device is a wireless network chip.

3. The modulation control scheme of claim 1, wherein the charge controller is configured to charge Li Iron Phosphate batteries.

4. The modulation control scheme of claim 1, wherein the electronic circuit comprises at least one capacitor.

5. The modulation control scheme of claim 1, wherein the electronic circuit comprises a direct current (DC) converter.

6. The modulation control scheme of claim 5, wherein the direct current converter is a buck/boost DC/DC converter.

7. The modulation control scheme of claim 1, wherein the charge controller is configured to analyze the at least one battery while reducing charging time of the at least one battery.

8. A modulation control scheme for a Maximum Power Control Tracking (M.P.P.T.) charge controller in a photovoltaic system including at least one battery and a photovoltaic panel, the modulation control scheme comprising an electronic circuit provided with an input connector to the photovoltaic panel, an electronic battery protection means for protecting the at least one battery from overcharging and undercharging, a wireless communication device operationally connected to the electronic battery protection means, and an output connector connecting the electronic circuit to the at least one battery.

9. The modulation control scheme of claim 8, wherein the electronic circuit comprises a buck/boost DC/DC converter.

10. The modulation control scheme of claim 8, wherein the charge controller is configured to charge Li Iron Phosphate batteries.

11. The modulation control scheme of claim 8, wherein the electronic circuit comprises at least one capacitor.
